(19) United States
(12) Patent Application Publication
(10) Pub. No.: US 2024/0393607 A1
(43) Pub. Date: Nov. 28, 2024

(54) APPARATUS AND METHOD FOR COMBINING COHERENT LASER BEAMS, LASER SYSTEM

(71) Applicant: TRUMPF LASER GMBH, Schramberg (DE)

(72) Inventors: Daniel Grossmann, Schramberg (DE); Malte Kumkar, Weimar (DE); Aleksander Budnicki, Waldkirch (DE)

(21) Appl. No.: 18/796,349

(22) Filed: Aug. 7, 2024

Related U.S. Application Data
(63) Continuation of application No. PCT/EP2023/053079, filed on Feb. 8, 2023.

(30) Foreign Application Priority Data
Feb. 14, 2022 (DE) 10 2022 103 417.8

(51) Int. Cl. G02B 27/10; G02F 1/01; H01S 3/00

(52) U.S. Cl. CPC G02B 27/1086; G02B 27/106; G02F 1/0121; H01S 3/0085; G02F 2203/50

(57) ABSTRACT

An apparatus for combining a plurality of coherent laser beams to form at least one combined laser beam includes a phase setting device for setting a respective phase difference between the coherent laser beams, and a gain device for amplifying the coherent laser beams. The amplified coherent laser beams are output coupled from the gain device. The apparatus further includes a measuring device configured to measure a respective actual phase difference between one of the amplified coherent laser beams and a further one of the amplified coherent laser beams or between the one of the amplified coherent laser beams and at least one reference laser beam.

### CROSS REFERENCE TO RELATED APPLICATIONS

This application is a continuation of International Application No. PCT/EP2023/053079 (WO 2023/152165 A1), filed on Feb. 8, 2023, and claims benefit to German Patent Application No. DE 10 2022 103 417.8, filed on Feb. 14, 2022. The aforementioned applications are hereby incorporated by reference herein.

### FIELD

Embodiments of the present invention relate to an apparatus and a method for combining coherent laser beams to form at least one combined laser beam, and to a laser system.

### BACKGROUND

DE 10 2020 201 161 A1 has disclosed an apparatus for combining a plurality of coherent laser beams, comprising a splitting device for splitting an input laser beam into the plurality of coherent laser beams, a plurality of phase setting devices for setting a respective phase of one of the coherent laser beams, and a beam combination device for combining the coherent laser beams, which emanate from a plurality of grid positions of a grid arrangement, to form at least one combined laser beam, with the beam combination device having a microlens arrangement with exactly one microlens array for forming the at least one combined laser beam.

U.S. Pat. No. 9,134,538 B1 has disclosed a system for coherently combining a multiplicity of optical beams, comprising a resonance cavity, a multiplicity of gain elements arranged within the resonance cavity, a beam-combining element which is in optical communication with the gain elements and serves to coherently combine the optical beams to form a coherent output beam, a sensor which is in optical communication with the beam combining element and serves to capture at least one portion of the coherent output beam and provide a feedback signal representative of the at least one portion of the coherent output beam, and a phase controller which is coupled to the sensor and serves to set a phase of at least one of the optical beams on the basis of the feedback signal.

WO 2017/125345 A1 has disclosed a phase control system for controlling the relative phase of two laser beams of a laser system to be coherently combined, permitting the provision of a phase-controlled sum laser beam.

### SUMMARY

Embodiments of the present invention provide an apparatus for combining a plurality of coherent laser beams to form at least one combined laser beam. The apparatus includes a phase setting device for setting a respective phase difference between the coherent laser beams, and a gain device for amplifying the coherent laser beams. The amplified coherent laser beams are output coupled from the gain device. The apparatus further includes a measuring device configured to measure a respective actual phase difference between one of the amplified coherent laser beams and a further one of the amplified coherent laser beams or between the one of the amplified coherent laser beams and at least one reference laser beam.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of an apparatus for combining a plurality of coherent laser beams according to some embodiments;

FIG. 2a shows a combination element which is embodied as a diffractive optical element and serves to combine amplified coherent laser beams to form a combined laser beam, according to some embodiments;

FIG. 2b shows a combination element which is embodied as a microlens array and serves to combine amplified coherent laser beams to form a combined laser beam, according to some embodiments;

FIG. 2c shows a lens element for focusing amplified coherent laser beams according to some embodiments;

FIG. 3 shows a schematic illustration of an output coupling device for partial output coupling of amplified coherent laser beams, in order to supply these to a measuring device, according to some embodiments;

FIG. 4 shows a schematic illustration of measuring units of the measuring device, with the measuring units each being used to measure a phase difference between pairs of mutually adjacent amplified coherent laser beams, according to some embodiments;

FIG. 5 shows a schematic illustration of measuring units of the measuring device, with the measuring units each being used to measure a phase difference between pairs of the same first and a further one of the coherent laser beams, according to some embodiments;

FIG. 6 shows a schematic illustration of a further configuration of measuring units in the measuring device according to some embodiments;

FIG. 7a shows a schematic illustration of an exemplary embodiment of a measuring unit, the measuring unit having three measuring paths with one measuring element each;

FIGS. 7b, 7c and 7d show schematic illustrations of laser pulses from the amplified coherent laser beams, which are each incident on the different measuring elements of the measuring unit according to FIG. 7a, with pairs of laser pulses being incident on the respective measuring elements with a different time offset in each case, according to some embodiments;

FIG. 8 shows a schematic illustration of an intensity profile, measured by means of a measuring element, as a function of a phase difference of respective laser pulses from two different amplified coherent laser beams, according to some embodiments;

FIG. 9a shows a schematic illustration of an exemplary embodiment of a measuring unit which comprises a single measuring element;

FIG. 9b shows a schematic illustration of laser pulses from the amplified coherent laser beams, with pairs of laser pulses being incident on the measuring element with a different time offset in each case and with different pairs being incident on the measuring element with a time offset, according to some embodiments;

FIG. 10 shows a schematic illustration of a further exemplary embodiment of a measuring unit which comprises a single measuring element;

FIG. 11 shows a schematic illustration of an exemplary embodiment of a measuring unit with one measuring element, with retardation elements being provided in order to create an offset phase difference of more than 2*pi;

FIG. 12a shows an example of a time curve of set target phase difference values between two amplified coherent laser beams according to some embodiments;

FIG. 12b shows an example of a temporal succession of measurements performed by means of a measuring device for the purpose of measuring actual phase difference values between the amplified coherent laser beams, according to some embodiments;

FIG. 12c shows an example of a time curve of a deviation between target phase difference values and actual phase difference values, according to some embodiments; and

FIG. 12d shows an example of a temporal sequence of an optimization of an assignment rule, on the basis of which the target phase difference values are set, according to some embodiments.

### DETAILED DESCRIPTION

Embodiments of the present invention provide an apparatus and a method, by means of which it is possible to realize a combination of coherent laser beams with increased temporal and/or spatial dynamics.

According to embodiments of the invention, the apparatus includes a phase setting device for setting a respective phase difference between the coherent laser beams, a gain device for amplifying the coherent laser beams, with amplified coherent laser beams being output coupled from the gain device, and a measuring device for determining phase differences between the amplified coherent laser beams, the measuring device being configured to measure a respective phase difference between one of the amplified coherent laser beams and a further one of the amplified coherent laser beams or between one of the amplified coherent laser beams and at least one reference laser beam for the purpose of determining the phase differences between the amplified coherent laser beams.

In particular, this allows respective pairwise measurement of phase differences between the amplified coherent laser beams present. From this, the respective phase differences and/or phase angles can be determined, in technically simple fashion, for all amplified coherent laser beams present. This enables effective, accurate and quick detection of the respective phase differences between the amplified coherent laser beams, and hence enables effective closed-loop control of the phase differences.

In the case of the apparatus according to embodiments of the invention, a measurement of phase differences between the coherent laser beams present can be performed with a high temporal resolution. For example, a duration with which the respective phase difference between the amplified coherent laser beams can be resolved is no more than 3 μs, preferably no more than 1 μs and preferably no more than 0.01 μs. In particular, the duration of the measurement of the respective phase difference is of the order of an inverse of a modulation frequency of the phase setting device.

For example, a measuring accuracy frequency with which the respective phase difference between amplified coherent laser beams can be resolved is at least 0.3 MHz and/or no more than 1 GHz and in particular no more than 100 MHz.

On account of the high temporal resolution of the phase difference measurements, the coherent laser beams can be combined with a high temporal and/or spatial resolution to form different combined laser beams. For example, this allows a quick variation of beam distributions and/or pulse parameters, and this for example in turn allows processing of workpieces with an increased speed and with an increased temporal and/or spatial resolution.

In particular, the measuring device is used to determine the phase differences for all amplified coherent laser beams present and/or, in pairwise fashion, between all amplified coherent laser beams present. In particular, the measuring device is used to determine the respective phase differences for all possible combinations of the amplified coherent laser beams present.

In particular, provision is made for a respective phase difference between the amplified coherent laser beams prior to their combination forming at least one combined laser beam to be measured by means of the measuring device.

The coherent laser beams can be pulsed laser beams or continuous wave laser beams. In particular, the coherent laser beams are ultrashort pulse laser beams.

In particular, the apparatus is configured to combine the amplified coherent laser beams to form the at least one coherent laser beam. In particular, the coherent laser beams and/or the amplified coherent laser beams in each case are laser beams serving the purpose of being combined to form the at least one combined laser beam.

In particular, the at least one reference laser beam is a laser beam serving in the measurement of respective phase differences between this laser beam and the amplified coherent laser beams. In particular, the at least one reference laser beam does not contribute to the combination of the amplified coherent laser beams to form the at least one combined laser beam, and/or the at least one reference laser beam is not added to the at least one combined laser beam by combination.

For example, the at least one reference laser beam can be a component of an input laser beam provided by means of a laser source, with one or more of the coherent laser beams being formed from said input laser beam. It is also possible for the at least one reference laser beam to be one of the coherent laser beams and/or amplified coherent laser beams.

For example, the gain device may comprise a fiber amplifier, slab amplifier, rod amplifier or disk amplifier.

Provision can be made for the gain device to comprise a frequency conversion stage or for the gain device to be assigned a frequency conversion stage of the apparatus.

In particular, a respective phase difference between the coherent laser beams and/or between the amplified coherent laser beams is settable by means of the phase setting device.

For the aforementioned reason, it may be advantageous for the measuring device to be configured to measure respective phase differences between combinations of two different ones of the amplified coherent laser beams or to measure respective phase differences between different combinations of in each case one of the amplified coherent laser beams and the at least one reference laser beam.

Different combinations should be understood in each case to mean combinations in which the two laser beams of the combination are different. For example, within the meaning of this application, two different combinations can be formed from three laser beams.

It may be advantageous for the measuring device to be embodied as a photonic integrated circuit, at least in portions. In particular, one or more portions or regions of the measuring device, for example a beam guidance of the amplified coherent laser beams, are embodied as a photonic integrated circuit. The measuring device may have great complexity on account of a multiplicity of measuring units and/or measuring elements and the associated beam guidance. The measuring device can be designed in technologically simple fashion by the embodiment of the measuring device as a photonic integrated circuit. In particular, this allows the measuring device to be embodied with a reduced number of individual component parts.

In particular, N coherent laser beams and/or N amplified coherent laser beams are provided, wherein the measuring device is configured to measure a respective phase difference for N-1 different combinations of in each case two of the N amplified coherent laser beams or to measure a respective phase difference for N different combinations of in each case one of the N amplified coherent laser beams and the at least one reference laser beam.

It may be advantageous if a respective phase difference between a first one of the amplified coherent laser beams and exactly one further one of the amplified coherent laser beams is measured, with the first one of the amplified coherent laser beams being different in all measurements and the exactly one further one of the amplified coherent laser beams being different in all measurements or the exactly one further one of the amplified coherent laser beams being the same in a subset of the measurements or in all measurements.

The exactly one further one of the amplified coherent laser beams is an amplified coherent laser beam that differs from the first one of the amplified coherent laser beams in each pairwise measurement. Thus, no phase differences between the same amplified coherent laser beam are measured.

For the same reason, it may be advantageous if a respective phase difference between one of the amplified coherent laser beams and the at least one reference laser beam is measured, with the amplified coherent laser beam being different in all measurements.

Provision can be made for at least one measurement group of a first type and/or at least one measurement group of a second type to be formed, by means of which phase differences between a first one of the amplified coherent laser beams and exactly one further one of the amplified coherent laser beams are measured in each case, with the first one of the amplified coherent laser beams being different in all measurements and with the exactly one further one of the amplified coherent laser beams being different in all measurements in the at least one measurement group of the first type and with the exactly one further one of the amplified coherent laser beams being the same in all measurements in the at least one measurement group of the second type.

In particular, provision can be made for the apparatus to comprise an output coupling device for partial output coupling of the amplified coherent laser beams, with partially output coupled amplified coherent laser beams being supplied to the measuring device in order to measure a respective phase difference between the amplified coherent laser beams. As a result, it is possible in particular to determine the phase differences between the amplified coherent laser beams prior to their combination forming the at least one combined laser beam.

In particular, partial output coupling should be understood to mean output coupling of a respective component and/or beam component of the amplified coherent laser beams.

In particular, an intensity and/or power of the partially output coupled amplified coherent laser beams is less than 10% of an intensity or power of amplified coherent laser beams incident on the output coupling device.

Provision can be made for the at least one reference laser beam to be input coupled into the measuring device by means of the output coupling device, with in that case a component of at least 90% and/or at least approximately 100% of the at least one reference laser beam being input coupled into the measuring device in particular.

In principle, it is also possible that the at least one reference laser beam is input coupled into the measuring device by means of a separate beam path which, in particular, does not lead through the output coupling device.

In particular, the output coupling device is arranged in a beam path of the amplified coherent laser beams. For example, in relation to a main propagation direction of the coherent laser beams and/or the amplified coherent laser beams, the output coupling device is arranged downstream of the gain device and/or upstream of a combination device of the apparatus.

In the present case, a first device and/or a first element of the apparatus being arranged downstream of a second device and/or a second element of the apparatus in relation to the main propagation direction should be understood to mean that the coherent laser beams or amplified coherent laser beams initially strike the second device and/or the second element and subsequently strike the first device and/or the first element. Then, the second device and/or the second element is arranged upstream of the first device and/or the first element.

For partial output coupling of the amplified coherent laser beams, the output coupling device for example comprises a partly reflective mirror element and/or a polarization beam splitter element and/or a fiber-based Y-splitter.

In particular, each of the coherent laser beams is partially output coupled and supplied to the measuring device by means of the output coupling device.

It may be advantageous if the measuring device for measuring the respective phase difference between the amplified coherent laser beams is used in each case to spatially superimpose a component of one of the amplified coherent laser beams and a component of a further one of the amplified coherent laser beams or used in each case to spatially superimpose a component of one of the amplified coherent laser beams and the at least one reference laser beam. In particular, a spatial superposition of the amplified coherent laser beam and the further amplified coherent laser beam or at least one reference laser beam is implemented in collinear fashion. The respective phase differences of components of the amplified coherent laser beams can be determined by a technologically simple intensity measurement on account of the collinear spatial superposition in particular, with no image processing, in particular, being required.

In particular, a collinear superposition of laser beams should be understood to mean that these are superimposed on the measuring device with at least approximately parallel and/or coincident beam axes, with the collinear superposition being implemented at respective measuring elements of the measuring device in particular. For example, the collinear superposition is implemented in a common waveguide.

In particular, intensities of spatial superpositions and in particular collinear spatial superpositions of in each case two of the amplified coherent laser beams are measured by means of the measuring device.

For example, the measuring device comprises a plurality of measuring units, with one of the amplified coherent laser beams and a further one of the amplified coherent laser beams being input coupled into a respective measuring unit.

A measuring unit in the measuring device comprises at least one measuring element for measuring the intensity of a spatial superposition of the two amplified coherent laser beams. For example, the measuring element is designed as a photodetector or comprises a photodetector. For example, the photodetector can be a fast photodetector and/or a clocked photodetector and/or a photodiode.

In particular, N coherent laser beams and/or N amplified coherent laser beams are provided, wherein the measuring device comprises at least N-1 measuring units which are configured to measure a respective phase difference between one of the N amplified coherent laser beams and a further one of the N amplified coherent laser beams, or wherein the measuring device comprises at least N measuring units which are configured to measure a respective phase difference between one of the N amplified coherent laser beams and the at least one reference laser beam.

In an embodiment, at least one measuring unit is provided, the latter comprising a single measuring element, with one of the N amplified coherent laser beams and a further one of the N amplified coherent laser beams or the at least one reference laser beam being spatially superimposed on the measuring element, and wherein the measuring device is configured to supply the measuring element and/or the measuring unit with a plurality of pairs of one laser pulse from the one of the N amplified coherent laser beams and one laser pulse from the further one of the N amplified coherent laser beams or from the at least one reference laser beam, the pairs being supplied to the measuring element and/or the measuring unit with a defined time offset.

Provision can be made for each measuring unit of the measuring device to comprise a single measuring element.

In particular, the different pairs supplied to the measuring element and/or measuring unit with a defined time offset have a different offset phase difference in each case.

In particular, an offset phase difference should be understood to mean a preset and/or predefined phase difference between two amplified coherent laser beams and in particular between respective laser pulses from these amplified coherent laser beams. In particular, the offset phase difference is an additional phase difference to one already present.

In particular, a pair of laser pulses should be understood to mean in each case a spatial superposition of two laser pulses at a measuring unit and/or at a measuring element of the measuring device, with the two laser pulses in the pair in each case being assigned to different amplified coherent laser beams.

If the amplified coherent laser beams are pulsed laser beams, then the defined time offset in a preferred embodiment corresponds to a repetition rate of the pulsed laser beams.

In principle, it is also possible that the measuring device is used to control a laser source of the apparatus, by means of which coherent laser beams are provided, for the purpose of creating different pairs of laser pulses with a defined time offset.

In an alternative to that or in addition, provision can be made for the apparatus to comprise a shutter device for the purpose of creating different pairs of laser pulses with a defined time offset, with the shutter device in particular being arranged in a beam path of the amplified coherent laser beams to be input coupled into the measuring device and/or of the at least one reference laser beam to be input coupled into the measuring device.

In particular, the shutter device is configured to interrupt or clear a passage of amplified coherent laser beams and/or of the at least one reference laser beam to the respective measuring unit of the measuring device.

In particular, this then allows the creation of different pairs of laser pulses with a defined time offset by a suitable control of the shutter device by means of the measuring device.

In particular, provision can be made for the shutter device to be controlled by means of the measuring device such that a passage of amplified coherent laser beams and/or of the at least one reference laser beam to the respective measuring unit is only cleared for a duration required to pass a specific pair of laser pulses to the assigned measuring unit and/or the assigned measuring element. In particular, this allows the use of measuring elements whose measurement bandwidth is lower than a modulation bandwidth of the laser pulses.

For example, the shutter device can have a mechanical or electro-optic embodiment. In particular, the shutter device can be embodied as a photonic integrated circuit.

In a further variant, provision can be made for at least one retardation element to be provided for the formation of different pairs of laser pulses with a defined time offset, said retardation element being configured to form a time-of-flight difference and/or a path length difference between the two amplified coherent laser beams which are superimposed at the respective measuring unit.

In a further embodiment, provision is made for at least one measuring unit which comprises at least two and preferably three or more measuring elements. In particular, the measuring device is then configured to supply the measuring elements with a respective pair of one laser pulse from the one of the N amplified coherent laser beams and one laser pulse from the further one of the N amplified coherent laser beams or from the at least one reference laser beam.

Provision can be made for each measuring unit of the measuring device to comprise at least two and preferably three or more measuring elements.

In particular, the pairs supplied to the different measuring elements in each case have a different offset phase difference.

In particular, at least two and preferably three or more different pairs are provided, the assigned laser pulses of which and/or the assigned amplified coherent laser beams of which in each case have different defined offset phase differences. The phase difference between these amplified coherent laser beams thus can be unambiguously determined, for example on the basis of a Clarke transform, by way of intensity measurements by means of the sensor element or elements.

Provision can be made for the measuring device to be used to control the phase setting device in order to form a plurality of pairs whose laser pulses in each case have a defined and/or different offset phase difference.

In an alternative to that or in addition, the provision of one or more retardation elements may be provided for the formation of a plurality of pairs with different offset phase differences, with in particular one or more measuring elements of the measuring device respectively being able to be assigned one or more retardation elements. In particular, a retardation element is used to create a path length difference between the two amplified coherent laser beams which are assigned to the respective laser pulses from a specific pair.

In particular, provision can be made for the measuring device to comprise at least one measuring unit having a measuring element, with the measuring device and/or the measuring unit being configured to superimpose at the measuring element two amplified coherent laser beams with an offset phase difference of more than 2*pi. For example, this can be realized by means of one or more retardation elements which are assigned to one of the two amplified coherent laser beams. In particular, this makes it possible to establish whether amplified coherent laser beams and/or respective laser pulses from the amplified coherent laser beams have a phase difference of more than 2*pi.

In particular, provision can be made for the measuring device to be configured to control the phase setting device in order to subject the respective phase difference between the amplified coherent laser beams to open-loop and/or closed-loop control. For example, the measuring device is assigned a control device for controlling the phase setting device, or the measuring device comprises a control device. In particular, the phase setting device is controlled on the basis of phase differences between the amplified coherent laser beams, as measured and/or determined by the measuring device. For example, this allows closed-loop control of the respective phase differences between the amplified coherent laser beams and in particular closed-loop control to given target values to be provided by means of the measuring device.

In particular, a change in the phase difference between the coherent laser beams performed by means of the phase setting device brings about a change in the phase difference between the corresponding amplified coherent laser beams.

In an embodiment, the apparatus comprises a splitting device for splitting an input laser beam into a plurality of coherent laser beams. For example, this allows the provision of a multiplicity of coherent laser beams by means of a single laser source.

In an embodiment, the apparatus comprises a combination device for combining the amplified coherent laser beams to form the at least one combined laser beam. For example, the combination device comprises at least one microlens array and/or at least one diffractive optical element and/or at least one interferometer optics system and/or at least one polarization-influencing element.

For example, the combination device comprises at least one diffractive optical element, with the at least one diffractive optical element comprising a grating structure with a periodic pattern, for example. For example, this allows realization of a combination of the coherent laser beams according to the “filled aperture” principle.

Provision can be made for the combination device to comprise at least one microlens array for combining the coherent laser beams. For example, this allows realization of a combination of the coherent laser beams according to the “mixed aperture” principle.

Provision can be made for the combination device to comprise a frequency conversion stage or for the combination device to be assigned a frequency conversion stage of the apparatus. In particular, the frequency conversion stage is disposed upstream of the combination device.

In principle, it is also possible for the amplified coherent laser beams to be combined to form the at least one combined laser beam without a combination device. For example, the amplified coherent laser beams are then combined by propagation in the far field to form the at least one combined laser beam (“tiled aperture” principle).

For example, at least one lens element can be provided for projecting the amplified coherent laser beams into at least one combined laser beam. For example, this allows realization of a combination of the coherent laser beams according to the “tiled aperture” principle.

In particular, provision can be made for the apparatus to comprise at least one laser source for providing the coherent laser beams.

According to embodiments of the invention, the laser system includes at least one laser source for providing coherent laser beams and an above-described apparatus for combining the coherent laser beams.

In particular, one or more laser sources may be provided for the provision of the coherent laser beams. In the case of a single laser source, a plurality of coherent laser beams are created by splitting an input laser beam provided by means of this laser source. In the case of a plurality of laser sources, at least one coherent laser beam is provided by means of each of the laser sources.

According to embodiments of the invention, in the method for combining coherent laser beams, provision is made for a respective phase difference between the coherent laser beams to be settable or set by means of a phase setting device, for the coherent laser beams to be amplified by a gain device, with amplified coherent laser beams being output coupled from the gain device, and for phase differences between the amplified coherent laser beams to be determined by means of a measuring device, with a respective phase difference between one of the amplified coherent laser beams and a further one of the amplified coherent laser beams or between one of the amplified coherent laser beams and at least one reference laser beam being measured for the purpose of determining the phase differences between the amplified coherent laser beams.

In particular, provision can be made for the phase setting device to be controlled by means of the measuring device and/or by means of a control device in order to subject the respective phase difference between the amplified coherent laser beams to open-loop and/or closed-loop control.

In particular, the specifications “at least approximately” or “approximately” should be understood to mean in general a deviation of at most 10%. Unless stated otherwise, the specifications “at least approximately” or “approximately” are to be understood to mean in particular that an actual value and/or distance and/or angle deviates by no more than 10% from an ideal value and/or distance and/or angle.

Elements which are the same or have equivalent functions are provided with the same reference signs in all of the figures.

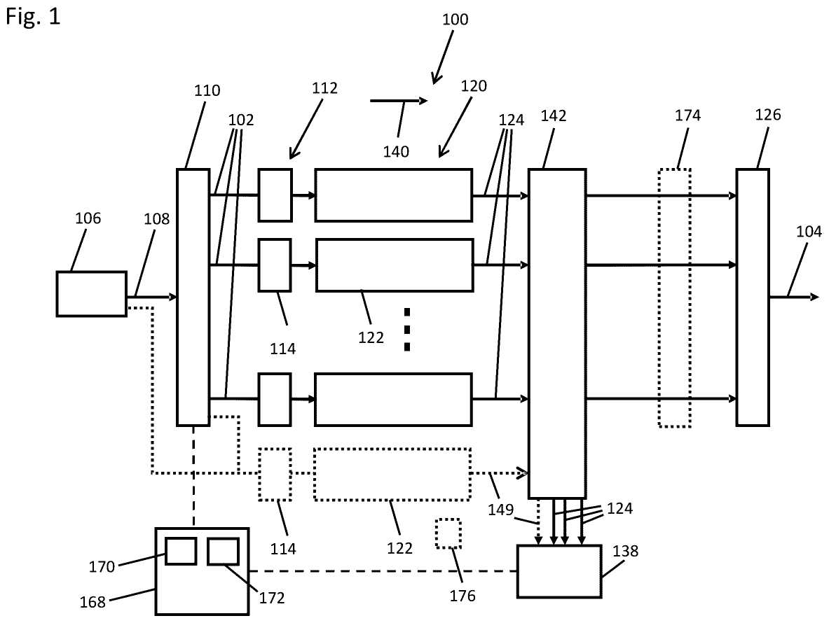

One exemplary embodiment of an apparatus for combining coherent laser beams is shown schematically in FIG. 1 and denoted by 100 therein. The apparatus 100 can be used to combine the coherent laser beams 102 (coherent beam combining), wherein one or more combined laser beams 104 are formed.

In the exemplary embodiment according to FIG. 1, provision is made for an input laser beam 108 to be provided by means of a laser source 106 and for a plurality of coherent laser beams 102 to be formed by splitting the input laser beam 108.

Alternatively, a plurality of laser sources 106 may also be provided for the provision of the coherent laser beams 102. For example, one or more coherent laser beams 102 are then provided by means of a respective laser source 106.

A splitting device 110 is provided for splitting the input laser beam 108 into a plurality of coherent laser beams 102. For example, FIG. 1 shows three coherent laser beams 102, which are formed by splitting the input laser beam 108 by means of the splitting device 110.

The input laser beam 108 and/or the coherent laser beams 102 are pulsed laser beams by way of example and ultrashort pulse laser beams in particular.

In particular, the coherent laser beams 102 have the same properties, for example the same wavelength and/or the same spectrum.

A phase setting device 112 is provided for setting a respective phase difference between the individual coherent laser beams 102. In particular, the phase setting device 112 comprises a plurality of phase setting elements 114, with a phase of an assigned coherent laser beam 102 being settable by means of a specific phase setting element 114. For example, a plurality or all of the coherent laser beams 102 are assigned a respective phase setting element 114.

In the case of N coherent laser beams 102, the phase setting device 112 comprises for example N-1 or N phase setting elements 114.

In respect of the technical details regarding the combination of coherent laser beams, reference is made to the following scientific publications: “Coherent combination of ultrafast fiber amplifiers”, Hanna, et al., Journal of Physics B: Atomic, Molecular and Optical Physics 49 (6) (2016), 062004; “Performance scaling of laser amplifiers via coherent combination of ultrashort pulses”, Klenke, Mensch und Buch Verlag; “Coherent beam combining with an ultrafast multicore Yb-doped fiber amplifier”, Ramirez, et al., Optics Express 23 (5), (2015), 5406-5416; and “Highly scalable femtosecond coherent beam combining demonstrated with 19 fibers”, Le Dortz, et al., Optics Letters 42 (10), (2017), 1887-1890.

The apparatus 100 comprises a gain device 120 for amplifying the coherent laser beams 102. In particular, the gain device 120 comprises a plurality of gain elements 122, with for example a respective one of the coherent laser beams 102 being assigned one gain element 122.

In the example shown in FIG. 1, the coherent laser beams 102 are input coupled into the gain device 120 or into the respective gain elements 122 of the gain device 120. In particular, the respective phase differences between the coherent laser beams 102 are set by means of the phase setting device 112 before the coherent laser beams 102 are input coupled into the gain device 120.

The coherent laser beams 102 which were amplified by means of the gain device 120 are referred to hereinbelow as amplified coherent laser beams 124. In the example shown, the number of coherent laser beams 102 present corresponds to the number of amplified coherent laser beams 124 present.

To combine the amplified coherent laser beams 124, provision is made for a combination device 126 in particular; it is used to form the combined laser beam 104 by combining the amplified coherent laser beams 124.

For example, amplified coherent laser beams 124 output coupled from the gain device 120 are input coupled into the combination device 126.

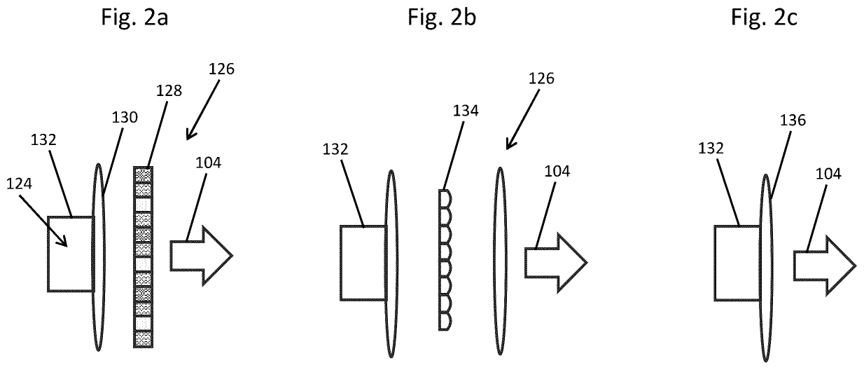

In an embodiment, the combination device 126 comprises a diffractive optical element 128 for combining the amplified coherent laser beams 124 (FIG. 2a). For example, a lens element 130 is provided for focusing the amplified coherent laser beams 124 on the diffractive optical element 128 (FIGS. 2a, 2b and 2c each indicate an envelope 132 of the amplified coherent laser beams 124 incident on the combination device 126 or on the lens element 130).

For example, the diffractive optical element 128 is or comprises a grating structure with a periodic pattern.

In respect of the technical details regarding the combination of coherent laser beams by means of diffractive optical elements, reference is made to the following scientific publications: “Coherent combination of ultrashort pulse beams using two diffractive optics”, Zhou et al., Opt. Lett. 42, 4422-4425 (2017) and “Diffractive-optics-based beam combination of a phase-locked fiber laser array”, Cheung et al., Opt. Lett. 33, 354-356 (2008).

In an alternative to that or in addition, provision can be made for the combination device 126 to comprise a microlens array 134 for combining the amplified coherent laser beams 124 (FIG. 2b).

In respect of the technical details regarding the combination of coherent laser beams by means of one or more microlens arrays, reference is made to WO 2020/016336 A1 and DE 102020 201 161 A1 by the same applicant.

In principle, it is also possible that the amplified coherent laser beams 124 are combined without a combination device 126. For example, the combined laser beam 104 is formed in that case by the superposition of the amplified coherent laser beams 124 in the far field.

In particular, a lens element 136 can then be provided for focusing the amplified coherent laser beams 124 (FIG. 2c).

For the purpose of measuring the respective phase difference Δφ between the amplified coherent laser beams 124, the apparatus 100 comprises a measuring device 138 which is arranged downstream of the gain device 120, for example in relation to a main propagation direction 140 of the coherent laser beams 102 and/or amplified coherent laser beams 124. In particular, the measuring device 138 is positioned between the gain device 120 and the combination device 126.

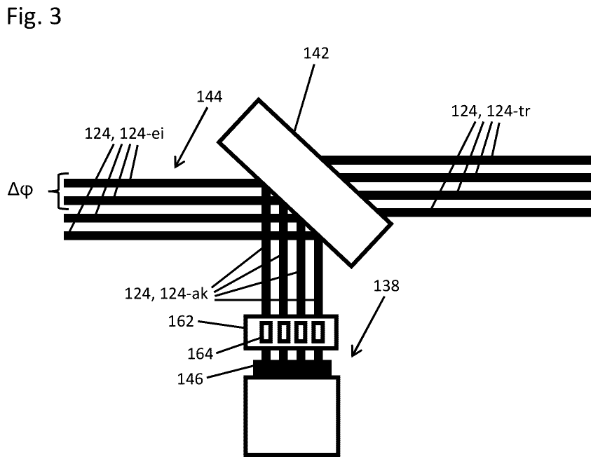

The various amplified coherent laser beams 124 in each case have a respective specific phase difference Δφ with respect to one another (indicated in FIG. 3), which is intended to be determined by means of the measuring device 138. The phase differences Δφ should be understood to mean actual phase difference values between the amplified coherent laser beams 124 and/or actual phase differences determined by means of the measuring device 138.

An output coupling device 142 can be provided in order to be able to supply the measuring device 138 with a component of the amplified coherent laser beams 124 (FIG. 3). In respect of the main propagation direction 140, this output coupling device 142 is in particular arranged downstream of the gain device 120 and/or upstream of the combination device 126.

For example, the output coupling device 142 is arranged in a beam path 144 of the amplified coherent laser beams 124. The output coupling device 142 is used to output couple beam components of the amplified coherent laser beams 124 in order to input couple said beam components into the measuring device 138.

Amplified coherent laser beams 124-ei incident on the output coupling device 142 are split into output coupled amplified coherent laser beams 124-ak and transmitted amplified coherent laser beams 124-tr by means of the output coupling device 142.

The output coupled amplified coherent laser beams 124-ak each are beam components of the amplified coherent laser beams 124. Components of the amplified coherent laser beams 124 are therefore fed to the measuring device 138 by means of the output coupling device 142.

In particular, a power and/or intensity of the output coupled amplified coherent laser beams 124-ak is/are less than 10% and in particular less than 5% of a power or intensity of the incident amplified coherent laser beams 124-ei.

The measuring device 138 comprises an input 146 for input coupling the beam components of the amplified coherent laser beams 124 into the measuring device 138. In particular, the respective beam components of the amplified coherent laser beams are input coupled into the measuring device 138 separately and/or with spatial separation.

The measuring device 138 comprises one or more measuring units 148. For example, the measuring device comprises N or N-1 measuring units in the case of N amplified coherent laser beams 124.

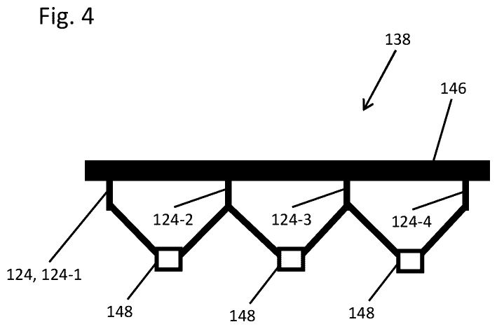

In the example shown in FIGS. 3 and 4, provision is made of four amplified coherent laser beams 124, the beam components of which are each input coupled into the measuring device 138. These—by way of example—four amplified coherent laser beams are denoted by 124-1, 124-2, 124-3 and 124-4 hereinbelow.

The measuring units 148 in each case are used to measure pairwise phase differences Δφ between the various amplified coherent laser beams 124, with the phase differences Δφ being determined in each case for different pairs and/or combinations of two of the amplified coherent laser beams 124.

In principle, it is also possible for the measuring device 138 and/or the measuring units 148 in the measuring device 138 to be used to measure respective pairwise phase differences Δφ between one of the amplified coherent laser beams 124 and a reference laser beam 149.

For example, the reference laser beam 149 can be a laser beam output coupled from the laser source 106 and/or a beam component of the input laser beam 108. It is also possible that the reference laser beam 149 is one of the coherent laser beams 102 output coupled from the splitting device 110 (both variants are indicated in FIG. 1 by the dotted line).

Provision can be made for the reference laser beam 149 to be assigned a phase setting element 114 and/or a gain element 122.

In a variant, the reference laser beam 149 is input coupled into the measuring device 138 by means of the output coupling device 142, with then in particular a component of at least 90% and/or at least approximately 100% of the reference laser beam 149 being input coupled into the measuring device 138 (indicated in FIG. 1).

Depending on the embodiment, the amplified coherent laser beam denoted by 124-1 in FIG. 4 may correspond to the reference beam 149, for example.

In principle, it is also possible that the reference laser beam 149 is input coupled into the measuring device 138 by means of a separate beam path (not shown here) which, in particular, does not lead through the output coupling device 142.

In the exemplary embodiment according to FIG. 4, a phase difference Δφ between the amplified coherent laser beams 124-1 and 124-2, 124-2 and 124-3 and also 124-3 and 124-4 is measured in each case, with the phase difference Δφ between the different pairs of two amplified coherent laser beams 124 being measured in each case by means of a different measuring unit 148.

In the example shown in FIG. 4, the phase difference Δφ is consequently measured in each case for three different combinations, each consisting of two of the amplified coherent laser beams 124-1, 124-2, 124-3, 124-4. Consequently, a respective phase difference Δφ between a first one of the amplified coherent laser beams 124-1, 124-2, 124-3, 124-4 and exactly one further one of the amplified coherent laser beams 124-1, 124-2, 124-3, 124-4 is measured, with the first and the exactly one further one of the amplified coherent laser beams 124-1, 124-2, 124-3, 124-4 respectively being different in all measurements.

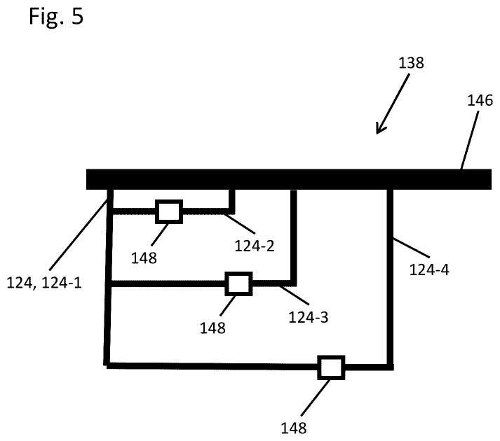

FIG. 5 shows a further embodiment of a measuring device 138. In this example, a respective phase difference Δφ between the amplified coherent laser beams 124-1 and 124-2 or 124-1 and 124-3 or 124-1 and 124-4 is measured by means of the different measuring units 148.

In the example shown in FIG. 5, the phase difference Δφ is consequently measured in each case for three different combinations, each consisting of two of the amplified coherent laser beams 124-1, 124-2, 124-3, 124-4. Consequently, a respective phase difference Δφ between a first one of the amplified coherent laser beams 124-1, 124-2, 124-3, 124-4 and exactly one further one of the amplified coherent laser beams 124-1, 124-2, 124-3, 124-4 is measured, with the first one of the amplified coherent laser beams 124-1, 124-2, 124-3, 124-4 respectively being different in all measurements and the exactly one further one being the same in all measurements (specifically the amplified coherent laser beam 124-1 in the example shown).

In a variant of the example shown in FIG. 5, the amplified coherent laser beam 124-1 can correspond to the reference beam 149.

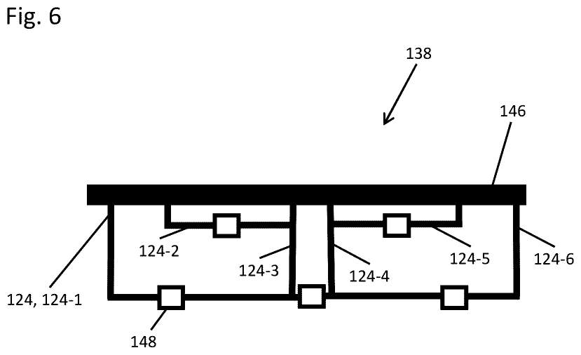

Six amplified coherent laser beams 124-1, 124-2, 124-3, 124-4, 124-5 and 124-6 are present in the example according to FIG. 6. In this example, the phase difference Δφ is measured in each case for five different combinations consisting of in each case two of the amplified coherent laser beams. A phase difference Δφ in each case between a first one of the amplified coherent laser beams and exactly one further one of the amplified coherent laser beams is measured, with the first one of the amplified coherent laser beams being different in all measurements and the exactly one further one of the amplified coherent laser beams being the amplified coherent laser beam 124-3 in three of the measurements (measurements between the amplified coherent laser beams 124-1 and 124-3, 124-2 and 124-3, 124-4, 124-3) and the amplified coherent laser beam 124-4 in two of the measurements (measurements between the amplified coherent laser beams 124-6 and 124-4, 124-5 and 124-6).

Beam guidance within the measuring device 138 can be free beam-based and/or fiber-based and/or waveguide-based, for example.

In a preferred embodiment, the measuring device 138 is embodied as a photonic integrated circuit (PIC), at least in portions. In this case—in a manner comparable to integrated circuits—optical components and/or beam guiding components are arranged on a substrate, for example a silicon substrate, a silicon nitride substrate and/or a lithium-niobate-on-insulator substrate.

In respect of the realization and properties of optical components and/or beam guiding components as a PIC, reference is made to the following scientific publication: “Direct and Sensitive Phase Readout for Integrated Waveguide Sensors”, by R. Halir et al., IEEE Photonics Journal, Volume 5, Number 4, August 2013, DOI: 10.1109/JPHOT.2013.2276747.

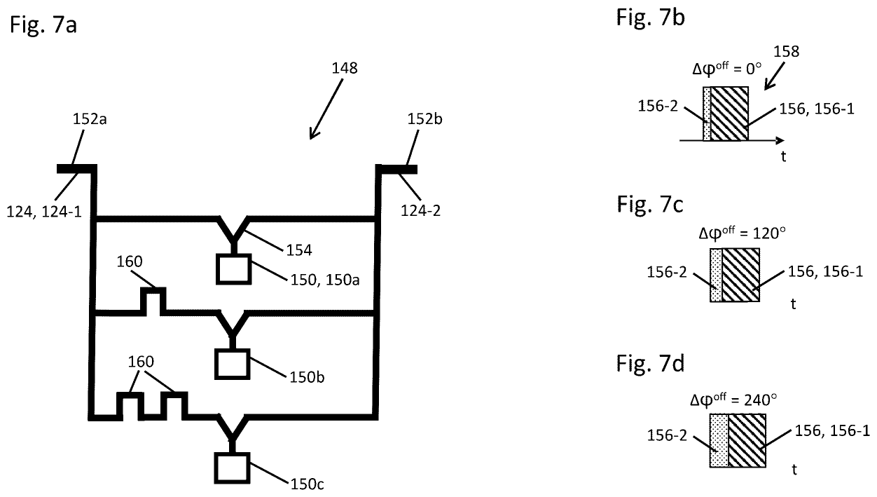

An exemplary embodiment of the measuring unit 148 is shown in FIG. 7. The measuring unit 148 comprises one or more measuring elements 150. Three measuring elements 150a, 150b, 150c are provided in the example shown.

The measuring element 150 is designed for time-resolved measurement of an intensity of a laser beam incident thereon or an intensity of a superposition of laser beams incident thereon. For example, the measuring element 150 is or comprises a photodiode.

The measuring unit 148 comprises a first input 152a for input coupling a first amplified coherent laser beam 124, for example the amplified coherent laser beam 124-1, and a second input 152b for input coupling a second amplified coherent laser beam 124, for example the amplified coherent laser beam 124-2.

The two amplified coherent laser beams 124-1 and 124-2 input coupled via the first input 152a and the second input 152b are superimposed and, in particular, superimposed collinearly at the measuring element 150.

A superposition element 154 is assigned to the measuring element 150 for the superposition of the two amplified coherent laser beams 124-1 and 124-2. For example, the superposition element 154 is embodied as a Y-coupler and in particular embodied as a fiber-based Y-coupler. For example, the superposition element 154 can be embodied as a multimode interference coupler (MMI coupler).

The two amplified coherent laser beams 124-1 and 124-2 are spatially split among the various measuring elements 150 of the measuring unit 148. In the example according to FIG. 7, the amplified coherent laser beams 124-1 and 124-2 are split among the three measuring elements 150a, 150b, 150c. To split the two amplified coherent laser beams 124-1 and 124-2 among the various measuring elements 150, provision is made for different beam paths for example.

The measuring device 138 and/or the measuring unit 148 are designed such that at least three different measurement values are determined by means of each measuring unit 148 for the amplified coherent laser beams 124 input coupled therein, with the different measurement values each being assigned a different offset phase difference Δφ^{off}.

If the amplified coherent laser beams 124 are pulsed laser beams, then the amplified coherent laser beams 124 each have laser pulses 156. The offset phase difference Δφ^{off} is then accompanied by a time offset, with which the respective laser pulses 156 from the two amplified coherent laser beams 124 are incident on the measuring element 150 (FIGS. 7b, 7c and 7d).

In the example shown in FIG. 7a, a respective measurement value for a pair 158 of a first laser pulse 156 and a further laser pulse 156 is recorded at one of the measuring elements 150, with in particular the respective offset phase differences Δφ^{off} being different at the various measuring elements 150 of the measuring unit 148. The first laser pulse 156 and the further laser pulse 156 are assigned to different ones of the two coherent amplified coherent laser beams 124 which are input coupled into the measuring unit 148 and/or into the measuring element 150.

In particular, the pair 158 should be understood to mean a spatial superposition of the first and the further laser pulse 156 at the measuring element 150, with these laser pulses 156 having a defined offset phase difference Δφ^{off} at the measuring element 150.

In FIGS. 7b, 7c and 7d, the laser pulses assigned to the amplified coherent laser beam 124-1 are denoted by 156-1, and the laser pulses assigned to the amplified coherent laser beam 124-2 are denoted by 156-2. FIG. 7b schematically shows the time offset of the laser pulses 156-1 and 156-2 incident on the measuring element 150a, FIG. 7c shows the time offset of the laser pulses 156-1 and 156-2 incident on the measuring element 150b, and FIG. 7d shows the time offset of the laser pulses 156-1 and 156-2 incident on the measuring element 150c.

Retardation elements 160 may be provided for the purpose of forming different offset phase differences Δφ^{off} between the laser pulses 156-1 and 156-2 at the various measuring elements 150, wherein one or more of the retardation elements 160 may be respectively assigned to one or more of the measuring elements 150.

For example, the retardation element 160 is designed to create a path length difference which for example results in a time offset and/or an offset phase difference Δφ^{off} between the laser pulses 156 in the pair 158.

In the example according to FIG. 7a, a respective retardation element 160 is for example embodied to form an offset phase difference Δφ^{off} of 120°.

In the example shown, no retardation element 160 is assigned to the amplified coherent laser beam 124-2 input coupled into the measuring elements 150a, 150b and 150c.

Further, no retardation element 160 is assigned to the measuring element 150a and/or the amplified coherent laser beam 124-1 input coupled into the measuring element 150a. For example, this results in an offset phase difference Δφ^{off} of 0° between the two laser pulses 156-1 and 156-2 at the measuring element 150a.

A single retardation element 160 is assigned to the measuring element 150b and/or the amplified coherent laser beam 124-1 input coupled into the measuring element 150b. For example, this results in an offset phase difference Δφ^{off} of 120° between the two laser pulses 156-1 and 156-2 at the measuring element 150b.

For example, two retardation elements 160 are assigned to the measuring element 150c and/or the amplified coherent laser beam 124-1 input coupled into the measuring element 150c. For example, this results in an offset phase difference Δφ^{off} of 240° between the two laser pulses 156-1 and 156-2 at the measuring element 150b.

Measurement values are captured at different offset phase differences Δφ^{off} for the two amplified coherent laser beams 124 assigned to the measuring unit 148 on account of the plurality of measurements performed by means of the measuring unit 148. These measurement values can be used to determine the actual phase difference Δφ between these two amplified coherent laser beams 124.

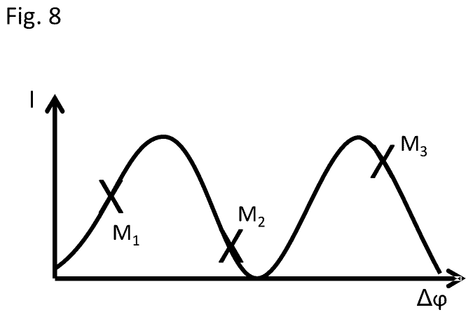

The measuring elements 150 of the measuring unit 148 are used to measure in each case intensities I of a superposition of the laser pulses 156-1, 156-2 associated with the pair 158, with the measured intensity I depending on the offset phase difference Δφ^{off} (FIG. 8). In particular, a respective measuring element 150 is used to measure a time-averaged intensity I of the laser pulses 156 in the pair 158 incident on the measuring element 150.

FIG. 8 shows an example of an intensity I measured at a measuring element 150 as a function of the phase difference Δφ. Three different measurement values M₁, M₂, M₃ are indicated in the example shown in FIG. 8, with for example the measurement value M₁ corresponding to the measuring element 150a and FIG. 7b (Δφ^{off}=0°), the measurement value M₂ corresponding to the measuring element 150b and FIG. 7c (Δφ^{off}=120°), and the measurement value M₃ corresponding to the measuring element 150c and FIG. 7d (Δφ^{off}=240°).

Measurement values for different offset phase differences Δφ^{off} are captured by means of different measuring elements 150 in the exemplary embodiment according to FIG. 7a, with for example a measuring element 150 being assigned in each case to a captured measurement value for a specific offset phase difference Δφ^{off}. In particular, in the example according to FIG. 7a, the various measuring elements 150 are used for a parallel measurement in time of pairs 158 of superimposed laser pulses 156 with different offset phase differences Δφ^{off}.

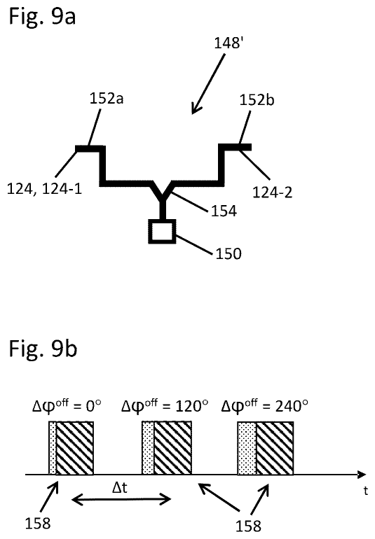

In an alternative to that, the embodiment of a measuring unit 148′ shown in FIG. 9a provides for measurements of pairs 158 of two laser pulses 156 to be performed for different offset phase differences Δφ^{off} with a time offset. The embodiment of the measuring unit 148′ shown in FIG. 9a differs from the embodiment described above and shown in FIG. 7a in that a single measuring element 150 is provided. Otherwise, the measuring unit 148′ has the same structure as the measuring unit 148, and so reference is made to the description of the latter in this respect.

In this embodiment, provision is made for the pairs 158 with different offset phase differences Δφ^{off} to be guided to the measuring element 150 in time-offset fashion, with the respective pairs 158 for example being incident on the measuring element 150 with a defined time offset Δt (FIG. 9b).

As a result, different measurement values M₁, M₂, M₃ are captured successively in time by means of the measuring element 150.

In this embodiment, the measuring device 138 is configured to provide the pairs 158 of two laser pulses 156 with a defined time offset Δt and respectively defined offset phase differences Δφ^{off}.

If the amplified coherent laser beams 124 are pulsed laser beams, then the defined time offset Δt in a preferred embodiment corresponds at least approximately to a repetition rate of the pulsed laser beams.

For example, the repetition rate is in the range of 1 MHz to 1 GHz.

In particular, provision can be made for the phase setting device 112 to be controlled by means of the measuring device 138 in order to provide pairs 158 with a defined offset phase difference Δφ^{off}. In particular, the measuring device 138 is configured to control the phase setting device 112 and/or is signal-connected to the phase setting device 112.

In principle, it is also possible that the laser source 106 is controlled by means of the measuring device 138 in order to provide pairs 158 with a defined time offset Δt. To this end, the measuring device 138 is for example signal-connected to the laser source 106 and/or to a control device of the laser source 106.

As an alternative to that or in addition, a shutter device 162 controllable by means of the measuring device 138 can be provided for the purpose of creating the pairs 158 with a defined time offset Δt; this shutter device is arranged in the beam path of the coherent laser beams 102 and/or of the amplified coherent laser beams 124 (FIG. 3).

The shutter device 162 is configured to interrupt or clear a passage of amplified coherent laser beams 124 to the respective measuring units 148 of the measuring device 138. For example, the shutter device 162 comprises a plurality of shutter elements 164, with a shutter element in each case being assigned to one of the amplified coherent laser beams 124.

By suitably controlling the shutter device 162 using the measuring device 138, it is possible to supply laser pulses 156 and/or pairs 158 of laser pulses 156 from the respective amplified coherent laser beams 124 to a specific measuring element 150 with a defined time offset Δt. In particular, this may be provided whenever the amplified coherent laser beams are continuous wave laser beams.

For example, one or more of the shutter elements 164 may be arranged in the respective beam path of the amplified coherent laser beams 124 that are input coupled into the measuring device 138. In principle, it is also possible that shutter elements 164 are assigned to a measuring unit 148 and/or a measuring element 150 or part of a measuring unit 148 and/or measuring element 150.

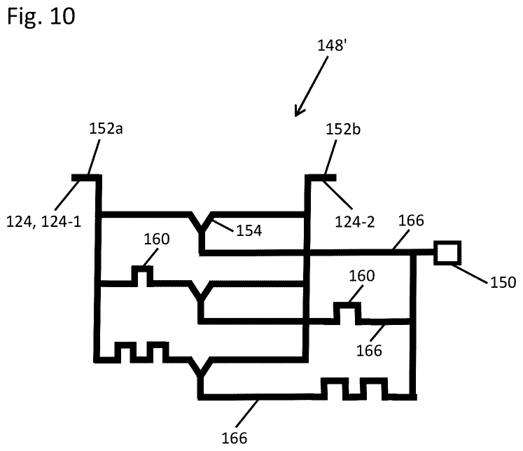

In principle, the pairs 158 of laser pulses 156 guided onto the measuring element 150 with a defined time offset Δt and a defined offset phase difference Δφ^{off} can also be created by splitting the amplified coherent laser beams 124-1, 124-2 input coupled into the measuring unit 148′ among different beam paths 166 (FIG. 10). In particular, the different beam paths are each configured to create a pair 158 with a defined offset phase difference Δφ^{off} and feed this pair to the measuring element 150 with a specific time offset Δt vis-à-vis a next or preceding pair 158. Retardation elements 160 arranged in the respective beam paths 166 may be provided to form the defined time offset Δt and the defined offset phase difference Δφ^{off}.

By preference, one or more retardation elements 160 and/or one or more beam paths 166 may be realized as a PIC.

In the example shown in FIG. 10, three different beam paths 166 are provided for the purpose of providing the measuring element 150 with three pairs 158 with a defined time offset Δt and a defined offset phase difference Δφ^{off}. A pair 158 is provided by means of each of the beam paths.

Provision can be made for the measuring device 138 to control the shutter device 162 for the purpose of performing a measurement, in order to supply pairs 158 of laser pulses 156 to the measuring units 148 and/or the measuring elements 150. In particular, the shutter device 162 is controlled such that the shutter elements 164 are open only for a duration required for the passage of a specific pair 158 of laser pulses 156 to the assigned measuring unit 148 and/or the assigned measuring element 150.

In particular, provision can be made for the measuring device 138 to be configured to supply the amplified coherent laser beams 124 to the respective measuring units 148 and/or measuring elements 150 at at least approximately the same intensity. To this end, provision can be made for the measuring device 138 to comprise gain elements.

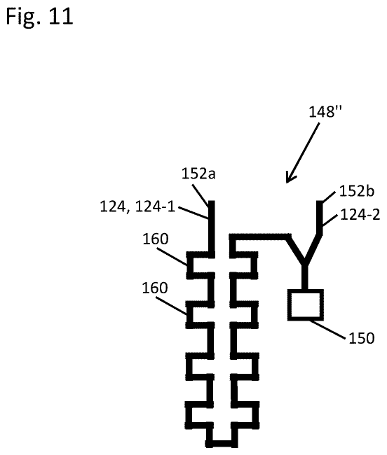

In an embodiment, provision can be made for the measuring device 138 to comprise at least one measuring unit 148″ having a measuring element 150, with provision being made for the two input coupled amplified coherent laser beams 124-1, 124-2 and/or the input coupled pair 158 of laser pulses 156 from these amplified coherent laser beams to have an offset phase difference Δφ^{off} of more than 2*pi (FIG. 11). For example, this can be realized by a multiplicity of retardation elements 160, which are assigned one of the two amplified coherent laser beams 124-1, 124-2 input coupled into the measuring unit 148″.

During operation of the apparatus 100, provision is made for the phase setting device 112 to be controlled in order to set the respective phase difference between the amplified coherent laser beams 124 to specified target phase difference values Δφ^{off}. Using the phase setting device 112, it is possible in the example shown to set the respective phase difference between the coherent laser beams 102 that are input coupled into the gain device 120, and this brings about a change in and/or setting of the respective phase difference between the assigned amplified coherent laser beams 124.

The apparatus comprises a control device 168 which controls the phase setting device 110 with specific control values on the basis of an assignment rule. The assignment rule contains an assignment of the control values to target phase difference values Δφ^{soll} between the respective amplified coherent laser beams. For example, the assignment rule is or comprises an assignment table.

For example, an initial version of the assignment rule is determined by calibration measurements. In these calibration measurements, the phase setting device 112 is controlled with certain control values by the control device 168, for example, and the resulting actual phase difference values Δφ are measured for these control values by means of the measuring device 138. As a result, relationships between the control values and the resultant phase difference values Δφ can be determined in order to define the assignment rule.

In particular, a memory device 170 can be provided, the latter being comprised by the control device 168 or assigned to the control device 168, with the assignment rule being stored in the memory device 170.

Deviations between the target phase difference values Δφ^{soll} set on the basis of the assignment rule and the actual phase difference values Δφ of the amplified coherent laser beams 124 actually present by means of the measuring device 138 may arise during the operation of the apparatus 100.

Provision is made for the assignment rule to be optimized when the apparatus 100 is in operation, in order to minimize the deviation between the target phase difference values Δφ^{soll} and the actual phase difference values Δφ. An optimization unit 172 assigned to the control device 168 is provided for performing the optimization.

The optimization unit 172 adapts the assignment rule at least in part and/or modifies the latter at least in part in order to minimize the deviation between the target phase difference values Δφ^{soll} and the actual phase difference values Δφ, with in particular a comparison between the target phase difference values Δφ^{soll} and the actual phase difference values Δφ being implemented for minimization purposes.

For example, the optimization unit 172 is used to update at specific time intervals the assignment rule stored for controlling the phase setting device 112 by means of the control device 168, i.e., replace the assignment rule with a new assignment rule adapted as described above.

The control device 168, the measuring device 138, the memory device 170 and the optimization unit are in each case signal-connected with one another (indicated by the dashed line in FIG. 1).

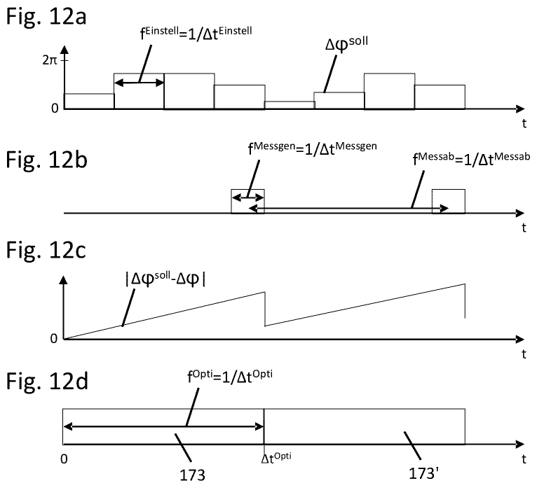

The phase setting device 112 is configured to set the respective phase difference between the coherent laser beams 102 and/or the amplified coherent laser beams 124 with a phase setting frequency f^{Einstell} to specified target phase difference values Δφ^{soll} (for example, FIG. 12a shows a time curve of set target phase difference values Δφ^{soll} between two of the amplified coherent laser beams 124). This phase setting frequency f^{Einstell} should be understood to mean a maximum frequency or a smallest time interval Δt^{Einstell}=1/f^{Einstell} with which the respective phase difference is changeable or modified. The phase setting frequency f^{Einstell} is also referred to as modulation frequency of the phase setting device.

In particular, the phase setting frequency f^{Einstell} is in the range of 1 MHz to 50 MHz.

The measuring device 138 is configured to determine the respective phase difference Δφ (actual phase difference) between the amplified coherent laser beams 124 with a measuring accuracy frequency f^{Messgen} (FIG. 12b). This should be understood to mean a greatest frequency or a shortest time duration Δt^{Messgen}=1/f^{Messgen} with which a phase difference can be resolved in time by the measuring device 138. The measuring accuracy frequency f^{Messgen} is also referred to as measurement bandwidth.

In particular, the measuring accuracy frequency f^{Messgen} is greater than or equal to the phase setting frequency f^{Einstell}.

The above-described measuring device 138 in particular enables measurements of the respective phase difference Δφ with a measuring accuracy frequency f^{Messgen} in the range of 1 MHz to 50 MHz.

Further, the measuring device 138 is configured to determine the respective phase difference Δφ with a measuring interval frequency f^{Messab} (FIG. 12b). This should be understood to mean a frequency or a time interval Δt^{Messab}=1/f^{Messab} with which the respective phase difference between the amplified coherent laser beams 124 is determined or determinable by means of the measuring device 138.

In particular, the measuring interval frequency f^{Messab} is in the range of 0.5 kHz to 5 kHz.

The optimization unit 172 is configured to optimize the assignment rule with an optimization frequency f^{Opti}. This should be understood to mean a frequency or a time interval Δt^{Opti}=1/f^{Opti} with which the stored assignment rule is adapted and/or updated by the optimization unit 172 in order to minimize the deviation between the target phase difference values Δφ^{soll} and the actual phase difference values Δφ (FIG. 12c).

In particular, the optimization frequency is in the range of 0.5 kHz to 5 kHz.

The optimization of the assignment rule with the optimization frequency f^{Opti} is shown schematically in FIG. 12d. In the time interval 0<t<Δt^{Opti}, the phase setting device 112 is controlled by the control device 168 on the basis of a first version 173 of the assignment rule. The assignment rule is replaced by an optimized version 173′ at the time t=Δt^{Opti}, whereby the deviation between Δφ^{soll} and Δφ is reduced at this time (cf. FIG. 12c).

Provision can be made for the apparatus 100 to comprise at least one additional measuring device 174, which is preferably disposed downstream of the measuring device 138 and/or downstream of the output coupling device 142 in relation to the main propagation direction 140. This additional measuring device 174 is designed to determine phase differences Δφ (actual phase differences) between the amplified coherent laser beams 124. Further, to transmit the determined phase differences Δφ to the control device 168, the additional measuring device 174 is signal-connected to the latter.

For example, the additional measuring device 174 can be arranged in a region of a combination device 126 and/or in a region of a workpiece (not shown here) to be processed by means of the at least one combined laser beam 104.

Further actual phase difference values Δφ, which can be taken into account when optimizing the assignment rule, can be determined by means of the additional measuring device 174. For example, for the purpose of optimizing the assignment rule, the optimization device 172 uses these actual phase difference values Δφ in addition to the actual phase difference values Δφ determined by the measuring device 138.

The measuring interval frequency f^{Messab} and/or the measuring accuracy frequency f^{Messgen} of the additional measuring device 174 can correspond to those of the measuring device 138 or differ from those of the measuring device 138. In particular, the measuring accuracy frequency f^{Messgen} of the additional measuring device 174 can be lower than that of the measuring device 138.

Provision can be made for the apparatus 100 to comprise one or more sensor elements 176 which are configured to measure at least one parameter which influences the respective phase difference Δφ between the amplified coherent laser beams 124.

For example, sensor elements 176 can be assigned in each case to the phase setting device 112 and/or the gain device 120.

For example, the sensor elements 176 can be configured to measure temperature.

The sensor elements 176 are signal-connected to the control device 168 and/or to the optimization unit 172 for the purpose of transmitting the captured measurement values. The measurement values captured by means of the sensor elements 176 are taken into account by the optimization unit 172 when optimizing the assignment rule.

The apparatus 100 according to embodiments of the invention operates as follows:

The input laser beam 108 is provided by means of the laser source 106 and input coupled into the splitting device 110. A plurality of coherent laser beams 102 are formed by splitting the input laser beam 108 by means of the splitting device 110. The coherent laser beams 102 are amplified by means of the gain device 120 and are output coupled as amplified coherent laser beams 124. Subsequently, one or more combined laser beams 104 are formed by combining the amplified coherent laser beams 124, with the combination being implemented by means of the combination device 126, for example.

To form the combined laser beams 104 with the desired properties, it is necessary to match the respective phase differences Δφ of the amplified coherent laser beams 124 to one another and to subject these to open-loop and/or closed-loop control.

To set the respective phase differences Δφ of the amplified coherent laser beams 124, the phase setting device 168 controls the phase setting device 110 with control values according to the assignment rule. As a result, the respective phase differences between the coherent laser beams 102 are set prior to their input coupling into the gain device 120, and this in turn brings about a setting of the respective phase differences Δφ of the amplified coherent laser beams 124.

The actual phase differences Δφ of the amplified coherent laser beams 124 are measured by means of the measuring device 138 and transmitted to the control device 168 and/or the optimization unit 172.

The optimization unit compares the set target phase difference values with the actually measured actual phase difference values Δφ between the amplified coherent laser beams 124 and subsequently calculates an updated assignment rule such that a deviation between the target phase difference values and the actual phase difference values Δφ is minimized.

For example, the assignment rule can be updated in a manner analogous to the calibration and linearization of nonlinear sensor curves on the basis of reference measurements. Corresponding methods can be adapted such that the calibration procedure is continually improved further on the basis of individual measurement values and, optionally, further sensor information is taken into account. For example, such methods are known from the following publications: “Lookup Table Optimization for Sensor Linearization in Small Embedded Systems”, L. E. Bengtsson, Journal of Sensor Technology, Vol. 2 No. 4, 2012, pp. 177-184, “A Linearisation and Compensation Method for Integrated Sensors”, P. Hille, R. Höhler and H. Strack, Sensors and Actuators A, Vol. 44, No. 2, 1994, pp. 95-102 and “Linearization of Analog-to-Digital Converters”, A. C. Dent and C. F. N. Cowan, IEEE Transactions on Circuits and Systems, Vol. 37, No. 6, 1990, pp. 729-737; reference is made thereto in the context of updating the assignment rule.

Provision can be made for the measurement values determined by means of the additional measuring device 174 and/or by means of the sensor elements 176 to be additionally used for the purpose of optimizing the assignment rule.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

I Intensity
M₁-M₃ Measurement value
Δφ Phase difference/actual phase difference value
Δφ^{soll} Target phase difference value
Δφ^{off} Offset phase difference
Δφ Time offset
f^{Einstell} Phase setting frequency
f^{Messab} Measuring interval frequency
f^{Messgen} Measuring accuracy frequency
f^{Opti} Optimization frequency
100 Apparatus
102 Coherent laser beam
104 Combined laser beam
106 Laser source
108 Input laser beam
110 Splitting device
112 Phase setting device
114 Phase setting element
120 Gain device
122 Gain element
124 Amplified coherent laser beam
124-ei Incident amplified coherent laser beam
124-tr Transmitted amplified coherent laser beam
124-ak Output coupled amplified coherent laser beam
124-1 Amplified coherent laser beam
124-2 Amplified coherent laser beam
124-3 Amplified coherent laser beam
124-4 Amplified coherent laser beam
126 Combination device
128 Diffractive optical element
130 Lens element
132 Envelope
134 Microlens array
136 Lens element
138 Measuring device
140 Main propagation direction
142 Output coupling device
144 Beam path
146 Input
148 Measuring unit
148′ Measuring unit
149 Reference laser beam
150 Measuring element
150a Measuring element
150b Measuring element
150c Measuring element
152a First input
152b Second input
154 Superposition element
156 Laser pulse
156-1 Laser pulse
156-2 Laser pulse
158 Pair of two laser pulses 160 Retardation element
162 Shutter device
164 Shutter element
166 Beam path
168 Control device
170 Memory device
172 Optimization unit
173 First version of the assignment rule
173′ Optimized version of the assignment rule
174 Additional measuring device
176 Sensor element

1. An apparatus for combining a plurality of coherent laser beams to form at least one combined laser beam, the apparatus comprising:
a phase setting device for setting a respective phase difference between the coherent laser beams,
a gain device for amplifying the coherent laser beams, wherein the amplified coherent laser beams are output coupled from the gain device, and
a measuring device configured to measure a respective actual phase difference between one of the amplified coherent laser beams and a further one of the amplified coherent laser beams or between the one of the amplified coherent laser beams and at least one reference laser beam.

2. The apparatus as claimed in claim 1, wherein the measuring device is configured to measure respective actual phase differences between different pairs of the amplified coherent laser beams or to measure respective actual phase differences between each one of the amplified coherent laser beams and the at least one reference laser beam.

3. The apparatus as claimed in claim 1, wherein the measuring device comprises a photonic integrated circuit.

4. The apparatus as claimed in claim 1, wherein the coherent laser beams comprise N coherent laser beams, and the amplified coherent laser beams comprise N amplified coherent laser beams, and wherein the measuring device is configured to measure actual phase differences between N-1 different pairs of amplified coherent laser beams or to measure a respective actual phase difference between each respective one of the N amplified coherent laser beams and the at least one reference laser beam.

5. The apparatus as claimed in claim 4, wherein the respective actual phase difference between a first one of the amplified coherent laser beams and a further one of the amplified coherent laser beams is measured, with the first one of the amplified coherent laser beams being different in all measurements and the further one of the amplified coherent laser beams being different in all measurements, or the further one of the amplified coherent laser beams being same in a subset of the measurements or in all measurements.

6. The apparatus as claimed in claim 1, further comprising an output coupling device for partial output coupling of the amplified coherent laser beams, wherein the partially output coupled amplified coherent laser beams are supplied to the measuring device in order to measure a respective actual phase difference between the amplified coherent laser beams.

7. The apparatus as claimed in claim 1, wherein the measuring device is used to spatially superimpose a component of the one of the amplified coherent laser beams and a component of the further one of the amplified coherent laser beams, or is used to spatially superimpose the component of the one of the amplified coherent laser beams and the at least one reference laser beam.

8. The apparatus as claimed in claim 1, wherein the coherent laser beams comprise N coherent laser beams, and the amplified coherent laser beams comprise N amplified coherent laser beams, and wherein the measuring device comprises at least N-1 measuring units, each measuring unit being configured to measure the respective actual phase difference between the one of the N amplified coherent laser beams and the further one of the N amplified coherent laser beams, or wherein the measuring device comprises at least N measuring units, each measuring unit being configured to measure the respective actual phase difference between the one of the N amplified coherent laser beams and the at least one reference laser beam.

9. The apparatus as claimed in claim 8, wherein at least one measuring unit comprises a single measuring element, with the one of the N amplified coherent laser beams and the further one of the N amplified coherent laser beams or the at least one reference laser beam being spatially superimposed on the measuring element, and wherein the measuring device is configured to supply the measuring element and/or the at least one measuring unit with a plurality of pairs of laser pulses with a defined time offset from each other, each pair of laser pulses comprising one laser pulse from the one of the N amplified coherent laser beams and one laser pulse from the further one of the N amplified coherent laser beams or the reference laser beam.

10. The apparatus as claimed in claim 8, wherein at least one measuring unit comprises at least two measuring elements, and wherein the measuring device is configured to supply each of the at least two measuring elements with a respective pair of laser pulses, the respective pair of laser pulses comprising one laser pulse from the one of the N amplified coherent laser beams and one laser pulse from the further one of the N amplified coherent laser beams or the at least one reference laser beam.

11. The apparatus as claimed in claim 10, wherein at least two different pairs of laser pulses are provided to the at least two measuring elements, the at least two different pairs of laser pulses having different defined offset phase differences.

12. The apparatus as claimed in claim 1, wherein the measuring device is configured to control the phase setting device in order to subject the respective actual phase difference between the amplified coherent laser beams to an open-loop and/or a closed-loop control.

13. The apparatus as claimed in claim 1, further comprising a beam splitting device for splitting an input laser beam into the plurality of coherent laser beams.

14. The apparatus as claimed in claim 1, further comprising a combination device for combining the amplified coherent laser beams to form the at least one combined laser beam.

15. The apparatus as claimed in claim 14, wherein the combination device comprises at least one microlens array and/or at last one diffractive optical element.

16. A laser system comprising at least one laser source for providing coherent laser beams and an apparatus for combining the coherent laser beams as claimed in claim 1.

17. A method for combining a plurality of coherent laser beams to form at least one combined laser beam, the method comprising:
setting a respective phase difference between the coherent laser beams by using a phase setting device,
amplifying the coherent laser beams by using a gain device, wherein amplified coherent laser beams are output coupled from the gain device, and determining actual phase differences between the amplified coherent laser beams by using a measuring device, wherein the measuring device is configured to measure a respective actual phase difference between one of the amplified coherent laser beams and a further one of the amplified coherent laser beams or between the one of the amplified coherent laser beams and at least one reference laser beam.
